(19) United States
(12) Patent Application Publication
(10) Pub. No.: US 2018/0142107 A1
(43) Pub. Date: May 24, 2018

(54) SURFACE COATING COMPOSITION

(71) Applicant: STO SE & CO. KGAA, Stühlingen (DE)

(72) Inventors: Andreas WEIER, Trossingen (DE); Christian SCHALLER, Neuhausen (DE); Walter WEH, Trossingen (DE); Gunter GERLACH, Hüfingen (DE); Gerald BURGETH, Lauchringen (DE)

(21) Appl. No.: 15/572,045

(22) PCT Filed: May 8, 2015
(86) PCT No.: PCT/EP2015/060255

§ 371 Date: Nov. 6, 2017

(51) Int. Cl. C09D 7/41; C09D 7/40; C09D 183/04; C09D 191/06; C04B 24/08; C04B 24/42

(52) U.S. Cl. CPC C09D 7/41; C09D 7/69; C09D 183/04; C04B 2103/54; C04B 24/08; C04B 24/42; C09D 191/06

(57) ABSTRACT

The present invention relates to a composition which contains—a wax (W), a silicone oil (S), —a binder (B), —one or more pigment(s) and/or filler(s) (PF1) of an average particle size of 0.1 to 1.0 μm in a total amount of 8.0 to 55 wt. %, —one or more pigment(s) and/or filler(s) (PF2) of an average particle size of more than 1.0 to 10 μm in a total amount of 5.0 to 40 wt. %, and one or more pigment(s) and/or filler(s) (PF3) of an average particle size of more than 10 to 40 μm in a total amount of 3.0 to 30 wt. %, in each case relative to the solids content of the composition, —PF1, PF2 and PF3 being different from each other, and to a coating which can be obtained from this composition. The invention further relates to the use of the composition according to the invention as a moulding or coating compound.

The present invention relates to a composition for coatings, in particular for surfaces exposed to external weathering, and a coating obtainable from this composition.

Surface coatings on external surfaces are generally exposed to weathering, that is to say rain, dew, etc. Rapid drying of these surfaces is desirable, since moisture on and within the surface promotes the growth of algae, fungi and other microorganisms, for example. The drying is normally achieved by evaporation and drain-off of the water, wherein one of these drying mechanisms is more dominant depending on the type of coating. The drying properties of a surface are also referred to generally as moisture management.

In commercially available coatings, one of the following principles is normally used.

Document EP 0 546 421 describes very or (highly) hydrophobic coatings. In this type of coating, water forms a high contact angle with the surface, whereby the water rolls off as droplets due to the force of gravity. When it is raining, these coatings generally lead to rapid drying. In the case of dew, however, small droplets often form on account of the condensation, that are too small to drip off.

In the case of (super) hydrophilic coatings, water has a very low contact angle and the water droplets on the surface form a large area on the surface. Depending on the water volume and spread of the water droplets, a film of water can form on the surface, whereby drying is accelerated by evaporation. However, a drying of surfaces of this kind normally starts only once the rain or dew, etc. has cleared up. In addition, the surface in the case of coatings of this kind absorbs a large amount of the moisture, which is undesirable, since for example the thermal insulation is reduced and microbial growth is promoted.

The object of the present invention is therefore to provide a composition for coating surfaces which has improved moisture management, i.e. leads to an improved re-drying of the surface, both when it is raining and in dewy conditions. The composition should lead to improved drying even in the case of inclined surfaces, i.e. surfaces that are not vertical.

The problem according to the invention has been solved by a composition containing
water and/or organic solvent
a wax (W)
a silicone oil (S)
a binder (B)
one or more pigment(s) and/or filler(s) (PF1) of an average particle size of 0.1 to 1.0 μm in a total amount of 8.0 to 55 wt. %,
one or more pigment(s) and/or filler(s) (PF2) of an average particle size of more than 1.0 to 10 μm in a total amount of 5.0 to 40 wt. %, and
one or more pigment(s) and/or filler(s) (PF3) of an average particle size of more than 10 to 40 μm in a total amount of 3.0 to 30 wt. %, in each case relative to the solids content of the composition,
PF1, PF2 and PF3 being different from each other.

The composition according to the invention and the resultant coating surprisingly have improved moisture management.

By means of a heterogeneous size distribution of the pigments and fillers, a person skilled in the art would expect a surface structure which has more irregularities and a higher coefficient of friction, since, in contrast to a homogeneous particle size distribution, in which all particles are (approximately) the same size, an arrangement of the particles in a spherical packing, similarly for example to salt crystals, etc., would not be expected.

With sub-critical formulations, which are preferred in the present application, the pigments and fillers are normally completely enclosed by the binder and therefore there are no direct interactions of the particle surface with water and/or particles of dirt. It is therefore all the more surprising that the pigment/filler combinations according to the invention reduce the coefficient of friction, i.e. the pigments and fillers influence the surface properties of the coating, without the surfaces of the pigments and fillers being part of the surface of the coating.

Due to the lower coefficient of friction obtained with the composition according to the invention, residue-free slide-off is improved, i.e. the formed water droplets slide off even if they are of a smaller size, and do not leave behind any water residues, such as run-off trails or run-off paths.

The pigment/filler combination according to the invention is also characterised in that the surface energy of the coating is hardly influenced by the pigments/fillers, in particular does not rise significantly, as would usually be expected by the addition of pigments and fillers. By contrast, in particular the polar component of the surface energy is significantly reduced by the filler combination according to the invention, which has an advantageous effect on the slide-off behaviour of the water droplets.

This is additionally assisted by the use of wax and silicone oil. Waxes and silicone oils are known to reduce the coefficient of friction of the surface, so that a particularly low coefficient of friction can be achieved by the combination with the pigments and fillers of the present invention.

In addition it is believed, independently of theoretical considerations, that the composition according to the invention and the resultant coating leads to an irregular distribution of the wax and binder at the surface, which appears to be a result of the addition of the silicone oil. To this end, EXAFS measurements have been performed, which show regions of increased silicon concentration, which appears to support the theory.

Water droplets formed on the surface are then disposed simultaneously in regions of the surface rich in wax and rich in silicone oil. These regions have different surface energies and consequently a different wetting behaviour. On account of the different wetting behaviour of these regions, it is assumed that the water droplet consequently attempts to produce different contact angles to the surface, which, particularly at the transition between regions having different wetting behaviour, leads to lower surface tensions and consequently to a quicker amalgamation of the droplets, which accelerates the run-off of the water.

Due to the lower coefficient of friction of the surface, the necessary size from which the droplet runs off due to the force of gravity becomes smaller, that is to say the drying behaviour is further improved. This leads to an improved moisture management, in particular in dewy conditions.

In addition, chemical and/or physical interactions between particles of dirt and the surface are significantly reduced by the composition according to the invention, in particular the low coefficient of friction, compared to coatings from the prior art. An adhesion of nonpolar and also polar particles of dirt is thus hindered. Should such particles nevertheless adhere, they are removed more easily by the water droplets rolling off or running off, since the interactions with the surface are less and therefore a lower force is sufficient to remove them from the surface.

The filler combination according to the invention will be described hereinafter in greater detail.

The total amount of pigment(s) and/or filler(s) of an average particle size of 0.10 to 1.0 μm is 8.0 to 55 wt. %, preferably 15 to 50 wt. %, more preferably 20 to 40 wt. %, in each case relative to the solids content of the composition. This/these pigment(s) and/or filler(s) contains/contain, preferably consists/consist of, pigment(s) and/or filler(s) (PF1).

The one or more pigment(s) and/or filler(s) (PF1) of an average particle size of 0.10 to 1.0 μm is/are preferably selected from pigment(s) and/or filler(s) of an average particle size of 0.15 to 0.80 μm, more preferably of an average particle size of 0.20 to 0.60 μm.

PF1 preferably has a Mohs hardness of at least 3.0, more preferably of at least 3.5, and particularly preferably of 4.0.

PF1 is preferably selected from metal oxides or metal sulphides, such as TiO₂, ZnO or ZnS, and/or from siliceous fillers, such as feldspar, quartz, cristobalite, diatomaceous earth and silicas, wherein PF1 is more preferably selected from metal oxides or metal sulphides, such as TiO₂, ZnO or ZnS, in particular TiO₂.

The total amount of pigment(s) and/or filler(s) of an average particle size of more than 1.0 to 10 μm is 5.0 to 40 wt. %, preferably 6.5 to 35 wt. %, more preferably 8 to 30 wt. %, in each case relative to the solids content of the composition. This/these pigment(s) and/or filler(s) contain, preferably consist of, pigment(s) and/or filler(s) (PF2).

The one or more pigment(s) and/or filler(s) (PF2) of an average particle size of more than 1.0 to 10 μm is/are preferably selected from pigment(s) and/or filler(s) of an average particle size of 1.5 to 9.0 μm, more preferably of an average particle size of 2.0 to 8.0 μm.

PF2 usually has a Mohs hardness of no more than 5.0, preferably no more than 4.0, and particularly preferably no more than 3.0.

PF2 is preferably selected from carbonates or sulphates, such as alkaline earth carbonates, calcite, chalk, gypsum, barium sulphate, and/or from siliceous fillers, in particular sheet silicates and clay silicates, such as talc, kaolin and mica silicates, and/or from oxides or hydroxides, for example Al(OH)₃, wherein PF2 is more preferably selected from carbonates or sulphates, such as alkaline earth carbonates, calcite, chalk, gypsum, barium sulphate, in particular calcium carbonate.

The total amount of pigment(s) and/or filler(s) of an average particle size of more than 10 to 40 μm is 3.0 to 30 wt. %, preferably 5.0 to 25 wt. %, more preferably 7.0 to 20 wt. %, in each case relative to the solids content of the composition. This/these pigment(s) and/or filler(s) contains/contain, preferably consists/consist of, pigment(s) and/or filler(s) (PF3).

The one or more pigment(s) and/or filler(s) (PF3) of an average particle size of more than 10 to 40 μm is/are preferably selected from pigment(s) and/or filler(s) of an average particle size of more than 10 to 35 μm, more preferably of an average particle size of more than 10 to 30 μm.

PF3 usually has a Mohs hardness of no more than 5.0, preferably no more than 4.0, and particularly preferably no more than 3.0.

PF3 preferably consists of anisotropic, for example lamellar, rod-like or platelet-like particles, i.e. the greatest spatial extent of the particles is much greater than the extent in a direction orthogonal thereto.

PF3 is preferably selected from carbonates or sulphates, such as alkaline earth carbonates, calcite, chalk, gypsum, barium sulphate, and/or from siliceous fillers, in particular sheet silicates and clay silicates, such as talc, kaolin and mica silicates and/or from oxides or hydroxides, for example Al(OH)₃, wherein PF3 is more preferably selected from sheet silicates and clay silicates, such as talc, kaolin and mica silicates, in particular sheet silicates, such as talc.

PF1, PF2 and PF3 are different from one another. PF1, PF2 and PF3 usually differ from one another in respect of their chemical composition and/or their average particle size, and PF1, PF2 and PF3 preferably differ from one another in respect of their chemical composition and their average particle size.

Due to the pigment/filler combination according to the invention, the coefficient of friction of the surfaces obtainable from the composition according to the present invention is further reduced. In addition, the polar component of the surface energies in particular is significantly reduced, as discussed above in detail.

The composition according to the invention can optionally contain a structuring filler. Due to the use of a structuring filler, the surface is provided with a microstructure, whereby the coefficient of friction is slightly increased. However, this increase is very small, and therefore the run-off behaviour of the water is hardly influenced. On smooth surfaces, water that is draining off often runs or rolls off over a few paths. Here, deposits can be formed along these paths. Due to the produced microstructure, water that is running off is directed into different paths, whereby deposits of this kind can be significantly reduced or spread out, so that a cleaning operation is less often necessary. In addition, any deposits formed in rainy/dewy conditions, etc. can be better removed again by water droplets that are draining off or rolling off.

Should there be a minor deterioration of the run-off behaviour (if there is any deterioration at all), this can be more than offset by the further improved self-cleaning properties.

The structuring filler usually has an average particle size of more than 40 to 160 μm, more preferably of more than 40 to 150 μm, even more preferably of 50 to 100 μm.

The structuring filler, if provided, is preferably a lightweight filler, usually having a bulk density of no more than 1.0 kg/dm³, preferably no more than 0.60 kg/dm³, and most preferably no more than 0.30 kg/dm³. Due to the use of a lightweight filler, the above-mentioned structure can be achieved with a low mass of filler. In addition, the lightweight fillers “float”, i.e. they move towards the surface of the coating, at and possibly also after application. The above-mentioned structure, if desired, can thus be achieved with a smaller amount of filler. However, the above-mentioned structure can also be achieved with a filler of higher bulk density.

The total amount of pigments and fillers of an average particle size of more than 40 μm to 160 μm, relative to the solids content of the composition, is usually preferably 0.10 to 6.0 wt. %, more preferably 0.20 to 4.0 wt. %, and most preferably 0.50 to 3.0 wt. %.

The totality of pigments and fillers of an average particle size of more than 40 μm to 160 μm contain, preferably consist of, the structuring filler.

The structuring fillers are, for example, glass beads, in particular half-hollow glass beads or hollow glass beads, foam glass, in particular closed foam glass, pearlite, in particular closed pearlite, expanded vermiculite, in particular closed expanded vermiculite, preferably glass beads, in particular half-hollow glass beads or hollow glass beads, and particularly preferably hollow glass beads.

The proportion by weight of pigment(s) and/or filler(s) of an average particle size of 0.10 to 1.0 μm is preferably greater than the proportion by weight of pigment(s) and/or filler(s) of an average particle size of more than 1.0 to μm, and/or, preferably and, the proportion of pigment(s) and/or filler(s) of an average particle size of more than 1.0 to 10 μm is preferably greater than the proportion of pigment(s) and/or filler(s) of an average particle size of more than 10 to 40 μm, in each case relative to the solids content of the composition.

The following relation (I) is preferably met

1.5·average particle size(PF1)<

average particle size(PF2)<

50·average particle size(PF1) (I),

the following relation (IA) is more preferably met

4.0·average particle size(PF1)<

average particle size(PF2)<

30·average particle size(PF1) (IA),

the following relation (IB) is even more preferably met

7.0·average particle size(PF1)<

average particle size(PF2)<

20·average particle size(PF1) (IB).

The following relation (II) is preferably met

1.5·average particle size(PF2)<

average particle size(PF3)<

40·average particle size(PF2) (II),

the following relation (IIA) is more preferably met

4.0·average particle size(PF2)<

average particle size(PF3)<

30·average particle size(PF2) (IIA),

the following relation (IIB) is even more preferably met

7.0·average particle size(PF2)<

average particle size(PF3)<

20·average particle size(PF2) (IIB).

The following relation (III) is preferably met

average particle size(PF3)<

average particle size(structuring filler) (III)

the following relation (IIIA) is more preferably met

1.4·average particle size(PF3)<

average particle size(structuring filler) (IIIA)

the following relation (IIIB) is even more preferably met

1.8·average particle size(PF3)<

average particle size(structuring filler) (IIIB).

Besides the pigments or fillers PF1, PF2, PF3 and the structuring filler, if provided, the composition according to the invention can contain further pigments and/or fillers.

The amount of pigments or fillers which differ from PF1, PF2 and PF3, including their preferred embodiments, and which differ from the structuring filler, if provided, including its preferred embodiments, is preferably no more than 15 wt. %, more preferably no more than 10 wt. %, relative to the solids content of the composition.

The amount of pigments or fillers which differ from PF1, PF2 and PF3 in their respective broadest embodiments in accordance with the present invention, and which differ from the structuring filler, if provided, in its broadest embodiment according to the present invention, is particularly preferably no more than 15 wt. %, more preferably no more than 10 wt. %, relative to the solids content of the composition.

The composition according to the invention preferably has a pigment-volume concentration according to EN ISO 4618-1 of 20% to 65%, more preferably of 25 to 60%, and even more preferably of 30 to 55%.

In the present invention the wax is usually more hydrophobic than the binder. In other words, the static initial contact angle of water after 1 min equilibration of the wax (W) is normally greater than the static initial contact angle of water of the binder (B) after 1 min equilibration.

The wax (W) therefore preferably has a static initial contact angle of water after 1 min equilibration which is greater than the static initial contact angle of water of the binder (B) after 1 min equilibration, wherein the wax (W) preferably has a static initial contact angle of water after 1 min equilibration that is at least 5°, preferably at least 10°, greater than the static initial contact angle of water of the binder (B) after 1 min equilibration.

The method for determining the static initial contact angle is described in the experimental part.

In the present application, “hydrophobic” means that the static initial contact angle of water after 1 min equilibration >90°.

In the present application, “hydrophilic” means that the static initial contact angle of water after 1 min equilibration ≤90°.

The wax usually has a static initial contact angle of water after 1 min equilibration of more than 90°, and the binder usually has a static initial contact angle of water after 1 min equilibration ≤90°, more preferably ≤80°, and even more preferably ≤75°.

The silicone oil preferably likewise has a static initial contact angle of water after 1 min equilibration that is greater than the static initial contact angle of water of the binder after 1 min equilibration. The static initial contact angle of water after 1 min equilibration of the silicone oil (S) is preferably at least 5°, preferably at least 10°, greater than the static initial contact angle of water of the binder (B) after 1 min equilibration.

The surface energy (OFE) consists of a polar and a dispersive component.

The polar component of the OFE of the binder (B) is preferably 2 to 20 mN/m, more preferably 4 to 15 mN/m, and/or the dispersive component of the OFE of the binder (B) is preferably 20 to 50 mN/m, more preferably 28 to 40 mN/m.

The OFE of the binder (B) is preferably 22 to 70 mN/m, more preferably 25 to 50 mN/m, even more preferably 30 to 45 mN/m.

The ratio between polar and dispersive component of the surface energy of the binder (B) is usually 10:90 to 50:50, preferably 15:85 to 50:50.

The polar component of the OFE is reduced by the addition of the wax (W) and/or silicone oil (S).

The wax (W) preferably reduces the polar component of the OFE by at least 8 percentage points, preferably by at least 12 percentage points, compared to the pure binder (B).

The reduction of the polar component of the OFE of the binder by the addition of the wax (W) and/or silicone oil (S) is preferably at least 2 mN/m, more preferably at least 4 mN/m, even more preferably 6 mN/m.

The ratio between polar and dispersive component of the surface energy of the wax (W) is usually 10:90 to 1:99, preferably 8:92 to 1:99.

The polar component of the average OFE of the wax (W) is preferably 0.1 to 6 mN/m, more preferably 0.5 to 4 mN/m.

The dispersive component of the average OFE of the wax (W) is preferably 22 to 52 mN/m, more preferably 28 to 48 mN/m.

The average OFE of the wax (W) is preferably 23 to 58 mN/m, more preferably 25 to 50 mN/m, even more preferably 29 to 38 mN/m.

The ratio between polar and dispersive component of the surface energy of the silicone oil (S) is usually 8:92 to 1:99, preferably 6:94 to 1:99.

The polar component of the average OFE of the silicone oil (S) is preferably 0.1 to 5 mN/m, more preferably 0.5 to 3 mN/m.

The dispersive component of the average OFE of the silicone oil (S) is preferably 25 to 50 mN/m, more preferably 30 to 45 mN/m.

The average OFE of the wax silicone oil (S) is preferably 20 to 70 mN/m, more preferably 26 to 50 mN/m, even more preferably 30 to 46 mN/m.

As explained above, a heterogeneous distribution of the silicone oil and of the wax appears to be preferred, whereby regions of high and low OFE expressed by different levels of polar and/or dispersive components of the OFE are formed on the surface. The polar component in particular varies widely.

The regions with high OFE normally correspond to the OFE of the binder, and the regions of low OFE normally correspond to the OFE of the wax.

The OFE of the composition is averaged from at least 5 pairs of measured values (water/diiodomethane) and thus constitutes an average value of the OFE (“average OFE”) of the regions with high OFE and of the regions with low OFE.

Due to the filler combination according to the invention, the surface energy of the composition is further reduced. In particular, the polar component of the surface energy is reduced.

The OFE of the composition is consequently lower than that of the binder (B) preferably by at least 1.5 mN/m, lower than that of the binder (B) preferably by at least 3 mN/m, and lower than that of the binder (B) more preferably by at least 5 mN/m.

The polar component of the average OFE of the composition is preferably 1 to 10 mN/m, more preferably 1 to 6 mN/m, even more preferably 1 to 5 mN/m.

The polar component of the average OFE of the composition is preferably at least 1 mN/m lower than the polar component of the average OFE of the binder (B), more preferably at least 2 mN/m lower than the polar component of the average OFE of the binder (B), even more preferably at least 3 mN/m lower than the polar component of the average OFE of the binder (B).

The dispersive component of the average OFE of the composition is preferably 14 to 59 mN/m, more preferably 20 to 50 mN/m, even more preferably 25 to 40 mN/m.

The average OFE of the composition is preferably 15 to 60 mN/m, more preferably 20 to 50 mN/m, even more preferably 23 to 35 mN/m.

The ratio of the dispersive component of the average OFE of the composition to the polar component of the average OFE of the composition is preferably 50:1 to 1:1, more preferably 40:1 to 2:1, even more preferably 10:1 to 5:1.

The low average OFE of the composition results above all from a low polar component of the OFE. It is known that silicone oil and wax usually reduce the OFE, in particular the polar component thereof. However, the polar component of the surface energy is reduced even further by the pigment/filler combination according to the invention, which leads to improved moisture management.

The binder (B) can be used as anhydrous and solvent-free re-dispersion powder or as aqueous and/or solvent-containing polymer dispersion. An aqueous and/or solvent-containing polymer dispersion is usually used. The non-aqueous solvents are usually organic solvents.

Organic solvents of this kind can be aliphatic or aromatic hydrocarbons, for example toluene, alcohols, esters or ketones, which are known as solvents for binders and coating materials.

The composition according to the present invention is usually provided in the form of an aqueous and/or solvent-containing dispersion. The total amount of water and solvents is usually 20 to 60 wt. % relative to the total amount of the composition.

The amount of added water or organic solvent is selected by a person skilled in the art depending on the intended application. In the case of dispersions, the proportion of water in a mixture formed of water and the aforementioned organic solvents is preferably more than 50 wt. % relative to the total mass of water and organic solvent.

In a preferred embodiment an aqueous dispersion is provided. An aqueous dispersion of this type can contain small amounts of organic solvents, which for example are contained in the reactants. In this case, the proportion thereof is usually no more than 5 wt. % relative to the total amount of the composition.

Organic solvents of this kind can be aliphatic or aromatic hydrocarbons, for example toluene, alcohols, esters or ketones, which are known as solvents for binders and coating materials.

The binder (B) usually contains at least 60 wt. % carbon relative to the total weight of the binder (B). Binders of this kind are normally formed from organic monomers, for example monomers containing C—C double bonds, monomers that can be polymerised by condensation or addition reactions.

Suitable binders or binder polymers are those based on monomers of carboxylic acid vinyl ester with 3 to 20 C atoms, for example vinyl acetate and vinyl propionate, N-vinylpyrrolidone and derivatives thereof, vinyl aromatics, for example styrene and derivatives of vinyl aromatics, such as derivatives of styrene, vinyl halides, ethylenically unsaturated carboxylic acids, for example acrylic acid and/or methacrylic acid, ethylenically unsaturated carboxylic acid esters, for example acrylic acid esters and/or methacrylic acid esters with 1 to 12 C atoms in the alcohol group, ethylenically unsaturated carboxylic acid amides or ethylenically unsaturated carboxylic acid anhydrides, acid esters such as acrylamides and acrylonitrile, preferably in the form of polymer dispersions as explained above. Water-soluble alkyd polymers, combinations of (meth)acrylic/alkyd polymers, polyvinyl alcohol and mixtures thereof can also be used. Here, polymers and/or copolymers (also referred to hereinafter as (co-)polymers for short) based on (meth)acrylate, for example based on acrylate, are particularly preferably used. In the sense of the present invention, (co-)polymers based on (meth)acrylate are those formed from (meth)acrylic acid and/or (meth)acrylic acid esters ((meth)acrylates) or mixtures thereof. The term (meth)acrylate and (meth)acrylic acid are understood in the present invention to mean both methacrylates or methacrylic acid and also acrylates or acrylic acid or respective mixtures thereof. Homopolymers of acrylic acid and in particular copolymers of acrylic acid and esters thereof, in particular alkyl esters, and/or homopolymers of methacrylic acid and in particular copolymers of methacrylic acid and esters thereof and/or esters of acrylic acid, in particular alkyl esters, are preferably used. The aforesaid copolymers of acrylic acid with alkyl acrylates are particularly preferred here. The use of copolymers which contain or are formed from methacrylic acid and/or acrylic acid and esters of methacrylic acid and/or esters of acrylic acid is thus particularly expedient. Among the esters, in particular alkyl esters, mentioned in this paragraph, methyl, ethyl, n-propyl, i-propyl, n-butyl, i-butyl, t-butyl and/or hexyl esters, for example 2-ethylhexyl esters, of (meth)acrylic acid, preferably acrylic acid, are particularly suitable.

Examples of suitable alkyl esters of acrylic acid and methacrylic acid are methyl acrylate, ethyl acrylate, propyl acrylate, butyl acrylate, 2-ethylhexyl acrylate, methyl methacrylate, ethyl methacrylate, propyl methacrylate, n-butyl methacrylate, t-butyl methacrylate, isobutyl methacrylate, 2-ethylhexyl methacrylate, cyclohexyl methacrylate and cyclohexyl acrylate. These alkyl esters can of course be used either alone or in the form of a combination of two or more alkyl esters. In addition or instead, alkyl esters of acrylic acid and/or methacrylic acid functionalised with functional groups, for example functionalised with hydroxyl or epoxy groups, can also be used. Suitable hydroxy-group-containing (meth)acrylic acid esters comprise hydroxymethyl methacrylate, hydroxyethyl acrylate, hydroxypropyl methacrylate, hydroxypropyl acrylate, hydroxybutyl methacrylate and hydroxybutyl acrylate. These alkyl esters can be used either alone or in combination. Examples of epoxy-group-containing (meth)acrylic acid esters are glycidyl methacrylate and glycidyl acrylate.

In addition, further unsaturated monocarboxylic acids and anhydrides thereof and/or in particular unsaturated dicarboxylic acids can be used as comonomers of acrylic acid, methacrylic acid and/or esters, in particular alkyl esters, of (meth)acrylic acid. For example, maleic acid, fumaric acid, itaconic acid and citraconic acid as well as the half esters thereof, for example with C1-C12 alcohols, are possible suitable unsaturated dicarboxylic acids.

Herein, aqueous binder dispersions based on acrylate (co-) polymers are particularly suitable. In addition, aqueous binder dispersions based on vinyl esters, for example vinyl acetate, styrene, styrene acrylate, butadiene, phenylacetylene and/or alkyd resin systems and copolymers thereof can also be used.

The proportion of the binder (B), relative to the solids content of the composition, is preferably 10 to 60 wt. %, more preferably 10 to 50, and particularly preferably 12 to wt. %, relative to the solids content of the composition.

The composition according to the invention can additionally also contain siliceous binders, for example water glass.

Water glass soluble in water, or a solution of water glass, usually aqueous solution, is preferred as water glass. Lithium, sodium, potassium water glasses or mixtures hereof are preferably used.

The silicone oil (S) usually contains predominantly nonpolar side chains, i.e. is nonpolar.

Silicone oils (S) predominantly containing hydrocarbyl side chains, such as C₁ to C₂₀ hydrocarbyl side chains, are preferred. Silicone oils predominantly containing alkyl side chains, for example C₁ to C₂₀ alkyl side chains, are particularly preferred, wherein alkyl chains containing no more than 5 carbon atoms are preferred in particular.

Branched and linear poly siloxanes with methyl, ethyl or propyl side chains are particularly preferred.

“Predominantly nonpolar side chains”, “predominantly hydrocarbyl side chains” or “predominantly alkyl side chains” means that the reactants used for the production of the silicone oils did not contain any polar side chains and/or precursors thereof.

In a preferred embodiment the silicone oil (S) contains exclusively hydrocarbyl side chains, even more preferably exclusively alkyl side chains according to one of the above-mentioned embodiments.

The silicone oil (S) preferably has no alkoxy side chains. The absence of alkoxy side chains can be determined by the absence of the symmetrical Si—O—C stretching vibration in the FTIR spectrum (940 to 970 cm⁻¹).

The silicone oil (S) preferably has a molecular weight of 1,000 to 20,000 g/mol, more preferably 4000 to 10,000 g/mol.

The silicone oil (S) preferably has a viscosity of 75 to 135 mm²/s, more preferably 85 to 125 mm²/s.

The composition preferably contains only silicone oils which have the above-mentioned properties or preferred embodiments thereof.

The amount of silicone oil is preferably 0.01 to 2.0 wt. %, more preferably 0.10 to 1.5 wt. %, more preferably 0.15 to 1.0 wt. %, in each case relative to the solids content of the composition.

The silicone oils used in the field of paint materials usually have a flow-promoting effect. The silicone oil used in the present invention, however, preferably does not have any flow-improving properties.

The wax preferably has a melting range within the range of to 150° C., more preferably 70 to 140° C., even more preferably 80 to 120° C., and most preferably 90 to 100° C. The wax is usually silicon-free.

Examples include natural waxes, for example beeswax, carnauba wax and paraffin wax, and synthetic waxes, such as polyalkylene waxes, polyamides, oxidised polyalkylene waxes, waxes from low-molecular copolymers of ethylene and acrylic acid or acrylates. Polyethylene or polyamide waxes or mixtures hereof with paraffin are particularly preferred, and polyethylene waxes or mixtures hereof with paraffin are most preferred. In the case of more than one wax, the amounts and specified temperature relate to the totality of the waxes.

The amount of the wax is preferably 0.10 to 10 wt. %, more preferably 0.2 to 5 wt. %, in each case relative to the solids content of the composition.

The composition can also contain up to 15.0 wt. %, preferably up to 10.0 wt. %, relative to the solids content of the composition, of conventional additives, for example rheological additives, dispersants, thickeners, wetting agents, film binding aids, biocides, anti-foaming agents, fibres, etc.

Following application of the coating and drying at room temperature for 48 h, the ratio between organic component of the coating and inorganic component of the coating is preferably 1.50 to 0.60, more preferably 1.30 to 0.80, and most preferably 1.25 and 0.90. The wet layer thickness used for this determination is usually 200 μm.

The composition is preferably a moulding or coating compound, more preferably a paint or render.

The invention is also directed to a coating on a substrate surface, the coating containing
a wax (W)
   a silicone oil (S)
a binder (B)
one or more pigment(s) and/or filler(s) (PF1) of an average particle size of 0.1 to 1.0 μm in a total amount of 8.0 to 55 wt. %,
one or more pigment(s) and/or filler(s) (PF2) of an average particle size of 1.0 to 10 μm in a total amount of 5.0 to 40 wt. %, and
one or more pigment(s) and/or filler(s) (PF3) of an average particle size of 10 to 40 μm in a total amount of 3.0 to 30 wt. %,
   in each case relative to the solids content of the composition,
PF1, PF2 and PF3 being different from each other.

The coating on the substrate surface is obtainable by use of the composition according to the invention.

The coating preferably has a coefficient of friction of no more than 0.28, more preferably no more than 0.24, and most preferably no more than 0.20. The method for determining the coefficient of friction is explained in the experimental part.

Due to the low coefficient of friction, the moisture management of the coatings obtained from the composition according to the invention is significantly improved as discussed above.

The preferred embodiments of the composition according to the invention are also preferred embodiments of the coating according to the present invention, and vice versa.

The substrate is preferably a wall, more preferably external surfaces which are exposed to weathering, for example external façades of buildings.

The invention is also directed to the use of the composition according to the invention as moulding or coating compound, wherein the moulding or coating compound is preferably a paint or render.

The preferred embodiments of the composition and the coating according to the invention are also preferred embodiments of the use according to the present invention, and vice versa.

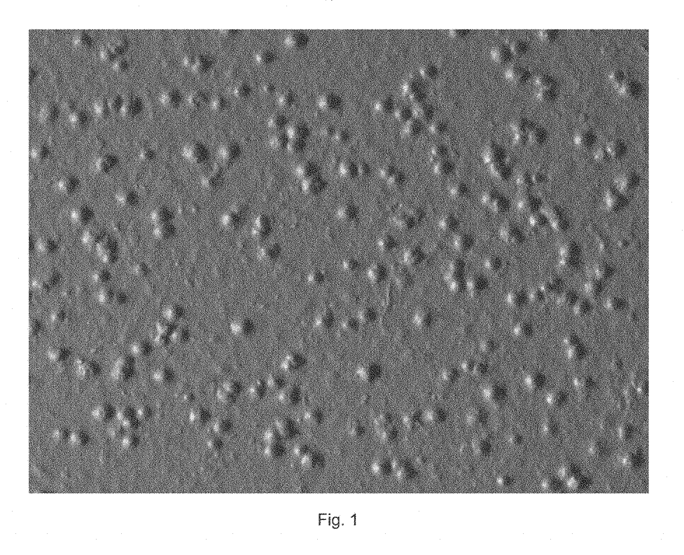

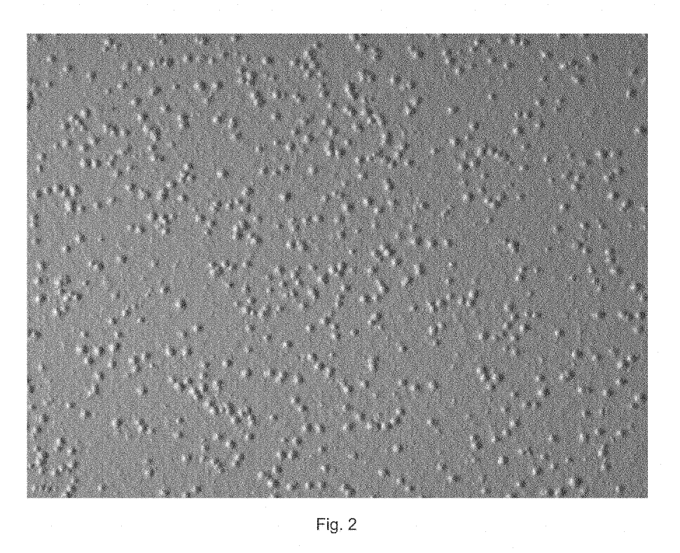

FIG. 1 shows the coating surface of a composition according to the invention additionally containing hollow glass beads at 20× magnification (light microscope).

FIG. 2 shows the coating surface of a composition according to the invention additionally containing hollow glass beads at 10× magnification (light microscope).

### MEASUREMENT METHODS

### Wax Melting Point:

ISO EN 11357-3

### Contact Angle and Surface Energy and Polar and Dispersive Component Thereof

Water and diiodomethane were used as test substances for the contact angle. The droplet size was 2 μl to 4 μl in each case.

Since a direct measurement of a wax surface is not possible in some circumstances, since the wax can crystallise out as it hardens and therefore a measurement is not possible or the wax can be too soft, a mixture of 3.85 wt. % wax and 96.15 wt. % of the binder specified below relative to the solids content was produced, and a corresponding coating created. The contact angle measurements were taken on this surface.

Silicone oils are normally viscous liquids, and therefore a direct measurement at the surface thereof likewise normally is not possible. A mixture of 1.13 wt. % silicone oil and 98.87 wt. % of the binder specified below relative to the solids content was therefore produced, and a corresponding coating created. The contact angle measurements were taken on this surface.

An aqueous dispersion based on a copolymer formed of acrylic and methacrylic acid esters having a solids content of 46 wt. % and a Brookfield viscosity of approximately 7000 mPa·s according to DIN EN ISO 2555 (spindle 4; 20 rpm; 23° C.), obtainable as Mowilith LDM 7724 from Celanese, was used as binder.

The static contact angle was determined after 2 days of drying at 23° C. and 50% relative humidity. After application of the water droplet or diiodomethane droplet, 60 sec were allowed to pass before the measurement was taken.

The contact angle at the three-phase contact line between solid, liquid and gas was determined using the G1 contact angle measuring device from Krüss. At least five droplets at different points were measured on each specimen.

The surface energy was determined by the Owens, Wendt, Rabel and Kaelble method as follows (source: Krüss AG).

According to OWENS, WENDT, RABEL and KAELBLE, the surface tension of each phase can be divided into a polar and a dispersive component:

σₗ=σₗ^{P}+σₗ^{D} (equation 1)

σₛ=σₛ^{P}+σₛ^{D} (equation 2)

OWENS and WENDT based their equation on interfacial tension

γₛₗ=σₛ+σₗ−2(\sqrt{σs^{D}·σₗ^{D}}+\sqrt{σₛ^{P}·σₗ^{P}}) (equation 3)

and combined it with the YOUNG equation

σₛ=γₛₗ+σₗ·cos θ (equation 4)

The two authors solved the equation system with the aid of contact angles of two liquids with known dispersive and polar component of the surface tension. Equations 3 and 4 are combined and the resultant equation is adapted to the general linear equation by conversion.

γ=mx+b (equation 5)

The adapted equation is as follows:

$$\underbrace{\frac{( 1 + cos θ ) \cdot {σ}_{l}}{2 \sqrt{{σ}_{l}^{D}}}}_{γ} = \underbrace{\sqrt{{σ}_{s}^{P}}}_{m} \underbrace{\sqrt{\frac{{σ}_{l}^{P}}{{σ}_{l}^{D}}}}_{x} + \underbrace{\sqrt{{σ}_{s} D}}_{b} \qquad ( equation 6 )$$

With a linear regression of the plotting of y against x, σₛ^{P} is given from the square of the line gradient m and σₛ^{D} is given from the square of the ordinate portion b.

The surface energies are specified in mN/m.

Mixtures formed of the pure, above-mentioned binder and the wax and/or silicone oil used in the examples described below will be examined first.

To this end, the compositions from Table 1 were prepared with a wet layer thickness of 200 μm and were dried as detailed above, and the contact angle after 3 min equilibration time of the droplet on the surface with water and diiodomethane, the surface energy (OFE), and the dispersive component (DA) and polar component (PA) of the OFE were determined.

The specified amounts in table 1 of the PE wax relate to an aqueous dispersion with a solids content of 35 wt. %, and those of the binder relate to an aqueous dispersion with a solids content of 46 wt. %. The silicone oil is present in the form of a cure compound.

TABLE 1

| | Contact | | | | | | | |
|---|---|---|---|---|---|---|---|---|
| | angle [°] | | | | | | | |
| | | Diiodo- | | | | DA | PA | DA/ |
| | Water | methane | OFE* | DA* | PA* | [%] | [%] | PA |
| Binder | 73.4 | 53.3 | 40.4 | 32.4 | 8.0 | 80.2 | 19.8 | 4.0 |
| Binder + | 91.7 | 54.2 | 33.5 | 31.9 | 1.6 | 95.3 | 4.7 | 20.2 |
| 5 wt. % wax | | | | | | | | |
| binder + | 88.4 | 44.4 | 38.9 | 37.3 | 1.6 | 96.0 | 4.0 | 23.9 |
| 0.5 wt. % | | | | | | | | |
| silicone oil | | | | | | | | |
| Binder + | 89.3 | 47.4 | 37.3 | 35.7 | 1.6 | 95.8 | 4.2 | 22.8 |
| 4.5 wt. % wax + | | | | | | | | |
| 0.5 wt. % | | | | | | | | |
| silicone oil | | | | | | | | |
| Binder + | 89.9 | 47.8 | 37.0 | 35.5 | 1.6 | 96.0 | 4.0 | 24.0 |
| 5 wt. % wax + | | | | | | | | |
| 0.5 wt. % | | | | | | | | |
| silicone oil | | | | | | | | |

*Unit [mN/m]

The significant increase of the contact angle of water can be seen for the addition of wax and/or silicone oil.

### Pigment-Volume Concentration

The pigment-volume concentration (EN ISO 4618-1) indicates the volume ratio between pigments/fillers and the binder in the coating film.

The additives likewise contained in the formulation were not taken into consideration in the calculation. Solvents and water also are no longer contained in the hardened film and are have thus also been omitted. The wax and silicone oil, if provided, were not taken into consideration in the calculation.

### Silicone Oil Viscosity

### DIN 53015

### FTIR (Absence of Symmetrical Si—O—C Stretching Vibration

The measurement was carried out using a Perkin-Elmer Spectrum 100 FTIR spectrometer with Universal ATR Accessory. The absence of the symmetrical Si—O—C stretching vibration at 94-970 cm⁻¹ indicates the absence of alkoxy side chains.

### Average Particle Size

In the present application the pigments and fillers are characterised on the basis of their average particle size. This is realised by determining the particle size distribution. The value dx here means the proportion in % (x) of the particles that have a diameter smaller than d. This means that the d20 value represents the particle diameter at which 20 wt. % of all particles are smaller than this diameter. The d50 value is consequently the volume-average median value, i.e. 50 vol. % of all particles are smaller than this particle size. In the present invention the particle size is specified as volume-average median value d50. In order to determine the volume-average median value d50, a Mastersizer 3000 laser diffraction particle size analyser from Malvern Instruments Limited, U.K. was used. The method and instrument are known to a person skilled in the art and are routinely used in order to determine particle sizes of fillers, pigments and other particulate materials.

The measurement was performed in water. The sample was dispersed by means of a high-speed agitator and ultrasound.

The average particle size corresponds to the d50 value.

### Bulk Density

The bulk density was determined in accordance with ISO 697.

### Coefficient of Friction

The dynamic coefficient of friction (μ_{R}) was determined in analogy with ISO 8295:1995 and ASTM D1894-11. An Altek Slip tester was used. A film with a wet layer thickness of 200 μm was formed on Lenetta film and dried for 3 days at room temperature. Three specimens (150×240 mm²) were cut in the application direction and held at 23° C. for at least 16 h in a thermostatically controlled environment. The test was also performed at this temperature. The sample was placed on the measuring table in such a way that the application direction of the coating matched the movement direction of the slide. The slide was made of stainless steel. The weight of the slide was 1.00 kg. The slide was then moved over the table at a constant speed (127 mm/min). The profile of the force over time was recorded. The mean force necessary to move the slide was determined as described in paragraph 9.2 of ISO 8295:1995. The dynamic coefficient of friction was then calculated as described in ISO 8295:1995 as

$${μ}_{R} = \frac{{F}_{f}}{w \cdot g}$$

wherein F_{f} is the dynamic frictional force in Newtons, w is the weight of the slide in kilograms, and g is the gravitational constant 9.81 m²/s.

### EXAMPLES

### Used Materials:

### Binder:

Aqueous dispersion based on a copolymer formed of acrylic and methacrylic acid esters having a solids content of 46 wt. %, a Brookfield viscosity of approximately 7000 mPa·s according to DIN EN ISO 2555 (spindle 4; 20 rpm; 23° C.) obtainable as Mowilith LDM 7724 from Celanese.

Titanium dioxide, average particle size=0.25 μm (example of PF1)

Calcium carbonate, average particle size−2.5 μm (example of PF2)

Sheet silicate, average particle size−25 μm (example of PF3)

Cristobalite, average particle size−14 μm (example of PF3)

### Hollow Glass Beads:

average particle size=50 μm

### Wax:

Polyethylene wax with a melting range from 91 to 99° C., a density of 1.00 g/cm³ and a viscosity of 25-50 mPa·s (DIN 53019 1.921 s−1). Dispersion with a solids content of 35 wt. %

### Silicone Oil

Alkoxy-group-free dimethylpolysiloxane having a viscosity of 90 mm²/s and a molecular weight of 6100 g/mol.

The following compositions were prepared.

R1: Formulation II from EP 0 546 421 (hydrophobic façade paint with a PVC (pigment volume concentration) of approximately 80%)

R2: Commercially available hydrophilic dispersion silicate paint with a PVC of approximately 82%)

All values in wt. %

TABLE 2

| | EG1 | EG2 | EG3 | EG4 | EG5 | A1 | A2 | A3 | B1 | C1 | R1 | R2 |
|---|---|---|---|---|---|---|---|---|---|---|---|---|
| Water | 13 | 14 | 4 | 20 | 31 | 19 | 14.5 | 17 | 19.5 | 18.5 | | |
| Binder | 40 | 40 | 49 | 33 | 22 | 40 | 40 | 40 | 40 | 40 | | |
| Wax | 5.0 | 5.0 | 5.0 | 5.0 | 5.0 | — | 5.0 | 5.0 | — | — | | |
| Silicone oil | 0.5 | 0.5 | 0.5 | 0.5 | 0.5 | 0.5 | — | 0.5 | — | — | | |
| TiO₂ | 16 | 16 | 16 | 16 | 16 | 16 | 16 | 16 | 16 | 16 | | |
| CaCO₃ | 10 | 10 | 10 | 10 | 10 | 10 | 10 | — | 10 | 10 | | |
| Sheet silicate | 9 | 9 | 9 | 9 | 9 | 9 | 9 | — | 9 | 9 | | |
| Cristobalite | — | — | — | — | — | — | — | 16 | — | — | | |
| Hollow glass beads | 1.0 | — | 1.0 | 1.0 | 1.0 | — | — | — | — | 1.0 | | |
| Additives¹⁾ | 5.5 | 5.5 | 5.5 | 5.5 | 5.5 | 5.5 | 5.5 | 5.5 | 5.5 | 5.5 | | |
| PVC [approx. %] | 45 | 36 | 40 | 50 | 60 | 36 | 36 | 36 | 36 | 45 | | |
| Contact angle water | 87.3 | 85.9 | 82.8 | 85.2 | 84.7 | 85.9 | 78.5 | 80.1 | 74.1 | 75.4 | 122.2 | 50.1 |
| [°] | | | | | | | | | | | | |
| Contact angle | 57.7 | 58.3 | 58.3 | 63.7 | 59.6 | 56.1 | 66.8 | 61.6 | 64.0 | 62.1 | 85.1 | 26.6 |
| diiodomethane [°] | | | | | | | | | | | | |
| OFE²⁾ | 33.02 | 33.18 | 34.31 | 31.15 | 33.07 | 34.17 | 32.89 | 34.06 | 36.11 | 36.16 | 14.98 | 61.42 |
| DA²⁾ | 29.92 | 29.55 | 29.54 | 26.46 | 28.83 | 30.83 | 24.70 | 27.63 | 26.25 | 27.38 | 14.96 | 45.92 |
| PA²⁾ | 3.11 | 3.63 | 4.77 | 4.68 | 4.25 | 3.34 | 8.19 | 6.44 | 9.86 | 8.78 | 0.02 | 15.51 |
| μR | 0.17 | 0.12 | 0.16 | 0.14 | 0.18 | 0.17 | 0.17 | 0.17 | 0.30 | 0.35 | 0.17 | 0.25 |

¹⁾in particular dispersant, thickener, anti-foaming agent, biocide
²⁾unit [mN/m]
EG = according to the invention, A, B, C = reference

The coefficient of friction was significantly reduced by the filler combination according to the invention, as can be seen from the comparison of EG2 (0.12) and A3 (0.17). In addition, the polar component of the surface energy is reduced by the pigment/filler combination according to the invention by almost half. Both compositions have the same PVC (36) and have the same binder content. They differ merely in that EG2 contains the pigment/combination according to the invention and A3 does not.

The use of glass beads (EG1/EG3/EG4/EG5) indeed increases the coefficient of friction. However, the glass beads produce a microstructure on the surface, as can be seen from FIG. 1 and FIG. 2. On smooth surfaces, water that is draining off often runs off over only a few paths. Here, deposits can be formed along these paths. Due to a microstructure produced by means of glass beads, water that is running off is directed into different paths, whereby deposits of this kind can be significantly reduced.

The re-drying of the compositions according to the invention was determined on the basis of the following tests.

To this end, samples with a wet layer thickness of 200 μm were created on Lenetta film and dried for 2 days at room temperature. The surface was 414 cm².

The coated Lenetta film was suspended from above and tared.

The film was then sprayed from a distance of approximately 35 cm with approximately 85 g/m² distilled water. Re-drying was observed for 30 min, and the weight was recorded every 5 min. The test was performed at a standard climate of 23° C./50% rel. humidity.

| | | | EG 1 with | | EG 2 | | | |
|---|---|---|---|---|---|---|---|---|
| | R1 | | HGB | | without HGB | | R2 | |
| | [g] | [%] | [g] | [%] | [g] | [%] | [g] | [%] |
| Start | 3.71 | 100.0 | 3.64 | 100.0 | 3.75 | 100.0 | 3.51 | 100.0 |
| 5′ | 3.29 | 88.7 | 2.21 | 60.7 | 2.1 | 56.0 | 2.20 | 62.7 |
| 10′ | 2.82 | 76.0 | 1.52 | 41.8 | 1.39 | 37.1 | 1.74 | 49.6 |
| 15′ | 2.34 | 63.1 | 1.01 | 27.7 | 0.96 | 25.6 | 1.25 | 35.6 |
| 20′ | 1.91 | 51.5 | 0.65 | 17.9 | 0.56 | 14.9 | 0.91 | 25.9 |
| 25′ | 1.45 | 39.1 | 0.36 | 9.9 | 0.27 | 7.2 | 0.57 | 16.2 |
| 30′ | 1.05 | 28.3 | 0.14 | 3.8 | 0.1 | 2.7 | 0.30 | 8.5 |

HGB = hollow glass beads

As the above table shows, the re-drying behaviour of the compositions according to the invention is significantly improved. The start drying speed is already significantly increased, as can be seen from the values at 5 and 10 minutes. In addition, the remaining water amount after 30 minutes is also significantly reduced.

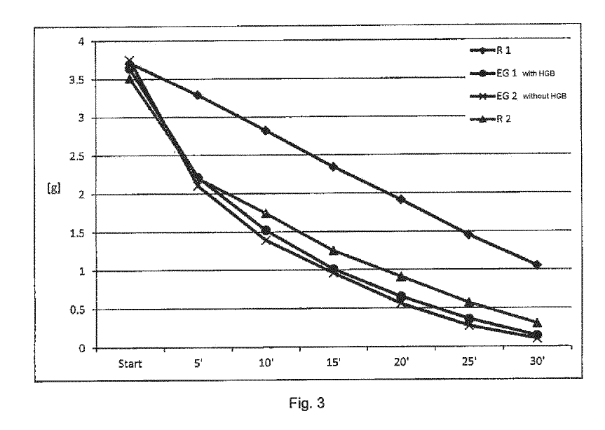

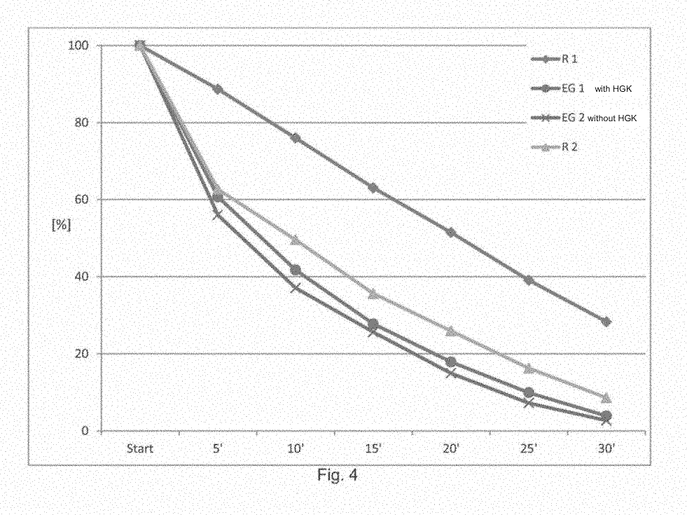

The course over time of the amount of water remaining on or in the surface is shown in FIGS. 3 (weight/time) and 4 (wt. %/time).

1. A composition containing
a wax (W)
a silicone oil (S)
a binder (B)
one or more pigment(s) and/or filler(s) (PF1) of an average particle size of 0.1 to 1.0 μm in a total amount of 8.0 to 55 wt. %;
one or more pigment(s) and/or filler(s) (PF2) of an average particle size of above 1.0 to 10 μm in a total amount of 5.0 to 40 wt. %; and
one or more pigment(s) and/or filler(s) (PF3) of an average particle size of above 10 to 40 μm in a total amount of 3.0 to 30 wt. %;
in each case relative to the solids content of the composition,
PF1, PF2 and PF3 being different from each other.

2. The composition according to claim 1, having a pigment-volume concentration according to EN ISO 4618-1 of 20% to 65%.

3. The composition according to claim 1, also containing a structuring filler.

4. The composition according to claim 3, wherein the structuring filler has an average particle size of more than 40 μm.

5. The composition according to claim 3, wherein the content of structuring filler relative to the solids content of the composition is 0.10 to 3.0 wt. %.

6. The composition according to claim 1, wherein the following relation (I) is met
1.5·average particle size(PF1)<
average particle size(PF2)<
50·average particle size(PF1) (I)

7. The composition according to claim 1, wherein the following relation (II) is met
1.5·average particle size(PF2)<
average particle size(PF3)<
40·average particle size(PF2) (II).

8. The composition according to claim 1, wherein the relative amount by weight of pigment(s) and/or filler(s) of an average particle size of 0.10 to 1.0 μm is greater than the relative amount by weight of pigment(s) and/or filler(s) of an average particle size of more than 1.0 to 10 μm, and/or the relative amount by weight of pigment(s) and/or filler(s) of an average particle size of more than 1.0 to 10 μm is greater than the relative amount by weight of pigment(s) and/or filler(s) of an average particle size of more than 10 to 40 μm, in each case relative to the solids content of the composition.

9. The composition according to claim 1, wherein the wax has a static initial contact angle of water after 1 min equilibration that is greater than the static initial contact angle of water of the binder after 1 min equilibration.

10. The composition according to claim 3, wherein the wax has a static initial contact angle of water after 1 min equilibration that is at least 5° greater than the static initial contact angle of water of the binder after 1 min equilibration.

11. The composition according to claim 1, wherein the composition is a moulding or coating compound.

12. The composition according to claim 11, wherein the composition is a paint or render.

13. A coating on a substrate surface, said coating containing
a wax (W)
a silicone oil (S)
a binder (B)
one or more pigment(s) and/or filler(s) (PF1) of an average particle size of 0.1 to 1.0 μm in a total amount of 8.0 to 55 wt. %;
one or more pigment(s) and/or filler(s) (PF2) of an average particle size of more than 1.0 to 10 μm in a total amount of 5.0 to 40 wt. %; and
one or more pigment(s) and/or filler(s) (PF3) of an average particle size of more than 10 to 40 μm in a total amount of 3.0 to 30 wt. %;
in each case relative to the solids content of the composition,
PF1, PF2 and PF3 being different from each other.

14. Use of a composition according to claim 1 as a moulding or coating compound.

15. The use according to claim 14, wherein the moulding or coating compound is a paint or render.
